(19) United States
(12) Patent Application Publication
(10) Pub. No.: US 2023/0208845 A1
(43) Pub. Date: Jun. 29, 2023

(54) SECURITY METHOD AND SYSTEM FOR RECEIVING AND VIEWING MEDIA

(71) Applicant: Devin Randolph, Gahanna, OH (US)

(72) Inventor: Devin Randolph, Gahanna, OH (US)

(21) Appl. No.: 18/117,322

(22) Filed: Mar. 3, 2023

Related U.S. Application Data
(63) Continuation-in-part of application No. 18/024,375, filed on Jan. 1, 0001.
(60) Provisional application No. 63/124,750, filed on Dec. 12, 2020.
(60) Provisional application No. 63/316,724, filed on Mar. 4, 2022.
(60) Provisional application No. 63/316,732, filed on Mar. 4, 2022.

(51) Int. Cl. H04L 9/40

(52) U.S. Cl. CPC H04L 63/102; H04L 63/0457

(57) ABSTRACT

A system and method for providing security for the transmission and displaying of media having a media repository having media, a media receiving unit for receiving media from the media repository and a display device for displaying the media, one or more sensors that operate to obtain scanned information which is transmitted to one or more identification data centers that compares the scanned information with reference information and a determination is made if an individual wishing to view the displayed media is an authorized individual and if not, the media is not displayed on the display device.

This application is Continuation-In-Part of U.S. patent application Ser. No. 18/024,375 filed on Mar. 2, 2023 entitled: Security Method and System For Receiving and Viewing Media, which claims benefit to U.S. Provisional Patent Application No. 63/124,750, filed in the U.S. Patent and Trademark Office on Dec. 12, 2020, Entitled: Ezekiel's Specification System; further, this Continuation-In-Part application claims benefit to and incorporates in its entirety to U.S. Provisional Patent Application No. 63/316,724, filed in the U.S. Patent and Trademark Office on Mar. 4, 2022, Entitled: Advanced Bone Conducting Bluetooth Skin Sensor Integrated Headphones and U.S. Provisional Patent Application No. 63/316,732, filed in the U.S. Patent and Trademark Office on Mar. 4, 2022, Entitled: The Financial Transaction Specification System.

### BACKGROUND OF THE INVENTION

Various types of content receiving systems having displays and/or sound systems (such as televisions, cell phones, computers, watches (like IPHONE watches), headsets, helmets, display units, tablets and the like) are used for receiving various types of media (such as movies, music, presentations, games, live broadcast and the like) from a media repository which is transmitted by way of the Internet, cable, satellite and other similar information and content streaming systems (“communication system”). Typically, such streaming systems stream transfer a sequence of images stored in a media repository (storage databank) and are sent in a compressed form, by a media repository, such as through a communication system (such as via the Internet or a cable service provider or a cellular phone service provider), to a content receiving system for displaying the media owned by and under the control of the media supply source or the media repository. The receiving system operates to receive the compressed media, uncompresses it and either displays the media or sends it to a display device.

As a result of significant increases in transmission rates and the convenience and time savings offered by on-line streaming, the demand for such services as greatly increased. This increase in demand for on-line streaming has grown not only for viewing prerecorded media but also for real time communication, such as for conducting real-time remote meetings, education instructions, and various types of private communications. In addition, media creators, such as movie production studios, are observing that with the availability of large-screen televisions and the availability of significant sound systems; media outlets, such as movie theaters, are being replaced by such in home entertainment centers. In addition, movie theaters, concert performers and others in the entertainment industry are concerned that shows and performances are being recorded by unauthorized individuals which can have a significant impact on the industry. Unlike movie theaters, where each individual wishing to view the media purchases a ticket, in home media centers allow multiple viewers to view the media for the same price as an individual. This will also have a significant impact on the media providers income. In addition, there continues to remain security concerns with respect to unauthorized or undetected individuals observing private or confidential media being transmitted and displayed.

Current security systems do not fully protect an individual who is simply securing the access to data by way of passwords. Individuals who have obtained access to information often risk unauthorized exposure to such information, such as when the individual temporarily walks away from the area (leaves the “media displaying environment”). For example, an employee that walks away from the media displaying environment, such as to get coffee or go to the restroom, the computer and/or display is at risk of being observed by an unauthorized individual. This unauthorized individual can now take pictures and/or make a copy of the displayed information. This is particularly problematic when the information is highly sensitive or confidential in nature. Another problem with current security systems is that they do not operate to protect the media being displayed on a display device by unauthorized on-lookers who may be observing the information being displayed without the authorized individual's knowledge or detected by the medial supply source or media repository. For example, if an individual wanted to cast a vote using on-line media but did not wish to have others know how the individual voted. In another example, a professor wanting to make sure that there were no other individuals around when a student was taking an on-line test.

One system that has been developed for preventing unauthorized individuals or cameras from obtaining information or media being displayed on a display device is shown and described in U.S. Patent Publication No. 2014/0078164 filed on Dec. 11, 2012 and incorporated herein in its entirety. While the system and method described herein operates to detect intruding cameras and unauthorized individuals from viewing from viewing images being shown on a display, the system operates such that an authorized user can set preferences for detecting an unauthorized individual or how the displayed information is edited. Further, the user can turn off the system thus allowing anyone to observed the displayed media. Thus, the media depository or media supply source (the media supplier, such as the streaming media or cable service provider) does not control or know who is viewing the media they are providing for viewing by an authorized individual, such as the individual that paid to see the media or if the media is being viewed by other individuals, who may not have paid to see or observed the displayed media.

Various methods have also been developed and have been shown to be effective in protecting and provide security of media streams between transferred through the communication system that include, but are not limited to, authorization, password encryption, pathway encryption, and media encryption methods. Unfortunately, until now, there has not been a method or system that operates to provide adequate security for the transmission and display of media content containing highly personal or confidential information or for ensuring that private information of an individual is being protected while stored in a data bank operated by the media repository or media supply source. In addition, until now, there has not been a system and method that operates to provide media providers (media repository and/or media supply source) the protection from the risk that unobserved and/or unauthorized individuals are able to view or hear media being displayed.

### SUMMARY OF THE INVENTION

The subject invention is a system and method that provides security for receiving and displaying media as it is being transmitted to a display device and for protecting private information stored in a data bank controlled by a media provider. Unlike prior art security systems, the method and system for providing security for receiving and viewing media, such as on-line streaming media, operates to provide security for the software and the devices used in the transmission and display of such media but also provides security private information of an authorized individual and for the media when being displayed for use by an individual or individuals. The system and method of the subject invention further operates to ensure that only an authorized individual or authorized individuals are able to view the media being transmitted to a display device. The system and method of the subject invention operates such that media being displayed to an authorized individual is protected from the point that the media is transmitted from a media repository to a media receiving unit, but also protects the media being displayed on a display device from being observed by unauthorized individuals.

The security system for receiving and viewing media of the subject invention can further operate to prevent not just the person (or the user) who is trying to view data or someone else's data but it also accounts for the user's or the individual(s)'s physical environment(s) and how they are viewing the data, such as for example their financial data in real time in those physical environments or as they make financial transactions for their streaming and/or online/internet user services. The system can be utilized for allowing an individual or individuals to access their finances, such as certain funds and the direction of where those funds will go and to whom will those funds be obtained by or who has access (to the amount) or who has access to withdraw or add funds to an account (permission usage) such as to use those funds to buy and/or sell online (streaming and/or online digital usage, internet usage).

The system for receiving and viewing media of the subject invention, unlike home surveillance (like) systems, ends up monitoring a specific environment or area with a direct purpose in mind, other than just recording. The system operates to observe an environment when the user(s) utilizes or wants to utilize their data or do a financial transaction. The overall premise of the system is to allow viewing and protect a user's/person's information, such as financial information in real time. In essence, the system not only protects a person's identity and transaction data through traditional software means or methods (e.g., passwords) but it also involves several biometric security operations or identifiers (incorporating a blend of the individual user and their environment more). The use of a combination of sensors that acquire different forms of identification information is much different than many home surveillance (like) system which is not fully focused, if at all focused on the protection of any data presented on a device and provides a system that cannot be fooled, such as by systems utilizing just facial images whereby a person having similar appearance to another individual, such as an authorized individual (an individual who is authorized to review the data, media, or perform a financial transaction) or by the use of false information, such as a photograph of an authorized individual that can be used to fool an image sensor. Further, unlike most streaming services which typically ask for a passcode (which depending on the camera angle most surveillance systems might not be able to see what a person is imputing or what card they are using (for example, another credit card that the individual is not authorized to use) or using another individuals device, such as another individual phone or computer.

The security system for receiving and viewing media of the subject invention operates for not just the person (or the user) who is trying to view data or someone else's data but it also accounts for the user's or the individual(s)'s physical environment(s) and how they are viewing the data, such as for example their financial data in real time in those physical environments or as they make financial transactions for their streaming and/or online/internet user services. The system that provides a system that can be utilized for allowing an individual or individuals to access their finances, such as certain funds and the direction of where those funds will go and to whom will those funds be obtained by or who has access (to the amount) or who has access to withdraw or add funds to an account (permission usage) such as to use those funds to buy and/or sell online (streaming and/or online digital usage, Internet usage).

In another example, when it comes to the selling of movie tickets (online) for newly released (or theatrical released [new, like shown for the first time]) movies, no one ever tries to identity who is truly (or actually) buying the movie ticket or the streaming or online/internet used service while observing the environment. For instance, a boy walks into his father's bedroom, takes his wallet and goes into his room and buys a movie ticket on a streaming channel (streaming service) with another credit card that was not on file with that streaming channel. The father does have an account for the streaming service on that streaming channel but the father did not authorize the purchase of the movie. Typically, one never catches the $30 charge to his account to watch the movie. The system of the subject invention would operate to not allow the son from making that online purchase in real time because the son cannot be identified physically as the father (the authorized individual). For example, in a preferred embodiment of the invention the system would operate to detect that the son was not the authorized individual (the father), such as, but not limited to checking the height of the requester (the son). In another preferred embodiment, the system also operates to notify the authorized individual (the father) and preferably also the streaming channel of this discovery or failing recognition. In another example of the operation of the system, in a preferred embodiment, if the father (authorized individual) gives permission to the son to buy a movie and the system operates to allow the son to purchase the movie and the number of movies (or type, such as only PG rated movies). Further, unlike systems whereby the security system utilizes only the display device, such as sensors that detect unauthorized potential viewers or cameras that may view media being displayed on the display device, the system of the subject invention is not limited to protecting media on that display device. For an example, if the son purchases a movie using his father's credit card, the son cannot use his display device to view the movie (and let other non-authorized individuals) to view the movie since the authorization user device would operate to stop the transmission of the media to the son's display device.

Unlike many other software security systems, the system is designed to observe not only the software or the computer or the devices that the data flows through, but it also manages the flow and the security of identification of the user making the digital transaction that is being used by that particular user (while they [the user] are in their environment(s) observing their data in real time). Therefore the focus for the system of the subject invention is more than just the computer and its viruses' or even the need to identify someone or provide a particular person granted access once or twice to display or provide their data temporally (which in doing so does not really insure that no one outside of that access granted user is physically around at that moment in time while that data is being displayed (which increases the risk of that fraud or someone being able to purchase streaming or online/internet that is being used). Without this system, data being captured (e.g., information on who or what and how they are being identified) or taken while that data is being displayed or visually provided or transferred or prepared]) the purchasing could be misused; an organization must have a system that insures that even when a user physically leaves their environment that no other unauthorized user will be able to purchase any streaming and/or online/data usage to view that data at any time, especially in that environment (this system does not necessarily need to be on 24/7 in order to do so as well). In other words (regarding software only based systems), most security systems or software security-based systems focus on either the software or the software element regarding security, especially through traditional means or methods (e.g., passwords, instead of the usage of a body part(s) like a finger to obtain a fingerprint through a fingerprint scanner to provide more protection).

Current systems do not fully account for the overall identity of the person who is using their own password specific accounts. These individual(s) who have access granted accounts to view their data or information, are at higher risk of exposing that information that they want protected, such as when they perform an action like temporarily walking away from the area when they are connected to certain sites. For an example when an individual logs into their computer and walks away from that computer for a few minutes, such as to get coffee, which means that this particular individual has not only left their computer alone allowing someone to see or look at their screen but if the individual has also left the location or original environment for the short period of time with their credit card connected to their account, they risk having their credit card information exposed, such as when an unauthorized individual walks into the area and has access to the computer and can take pictures and/or copy and paste and store that data onto a flash drive and make a purchase and walk away with that information that the authorized individual is unaware of. The security system for receiving and viewing media of the subject invention would operate to prevent this use of information by unauthorized individuals.

In a preferred embodiment, the security system for receiving and viewing media being viewed by an individual or individuals comprises: a media source; an authorization user device in communication with the media source and receives and implements commands from the media source; a media receiving unit that is in communication with the authorization user device; a communication system for transmitting media in real time from the media source to the media receiving unit; a display device in communication with the media receiving unit and operates to display the media; one or more sensors that operate to obtain scanned information of an individual viewing the media being displayed on the display device, wherein the scanned information is transmitted in real-time to one or more identification data centers having databanks for storing reference information; wherein the one or more data centers operate to make a comparison of the scanned information with the reference information; and wherein the media repository or the one or more identification data centers operate to make a determination if the individual viewing the media is an authorized individual, and if the determination is that the individual is not an authorized individual, the medial source communicates with and sends a command to the authorization user device to stop sending the media to the media receiving unit.

In a preferred embodiment of the invention the scanned information is transmitted to the authorization user device that encrypts the scanned information and transmits the encrypted scanned information to the one or more data centers whereby the encrypted scanned information is then re-encrypted when received by the one or more data centers.

In a preferred embodiment of the invention the one or more sensors operate to obtain scanned information which is used to determine if an individual has entered the display viewing area and wherein if an individual has entered the display viewing area, transmission of the media to the display device is stopped.

In a preferred embodiment of the invention the scanned information is used by the one or more identification information centers to make a determination if an object capable or being used to record media being displayed on the display device or for transmitting the media to a location outside the display viewing area.

In another preferred embodiment of the invention, the display device is in the form of a headset.

In another preferred embodiment of the invention, the display device is in the form of a headset for use by an authorized individual and includes one or more sensors that operate to transmit scanned information to the one or more individual data centers and a determination is made if the individual wearing the headset is an authorized individual.

In another preferred embodiment of the invention, the display device includes a sound system that utilizes conventional bone conducting technology for transmitting sound waves converted into vibrations that are received directly by a user's Cochlea. This display device can also be integrated with one or more sensors (E.g., skin sensors).

In another preferred embodiment of the invention, one or more sensors are placed within the display viewing area and scanned information is transmitted to one or more identification data centers and wherein a determination is made as to the number of individuals within the display viewing area.

In another preferred embodiment of the invention, one or more sensors are placed within the display viewing area that operate to obtain scanned information and the scanned information is transmitted to the one or more identification data centers and wherein a determination is made if an authorized individual viewing the media being displayed on the display device has entered or left the media viewing area.

In another preferred embodiment of the invention wherein the display device is in the form of a computer or a tablet or a cellular telephone or a headset, or a helmet, or a watch, or a gaming system, or a television or a large screen system or a vehicle windshield or a display unit.

In another preferred embodiment of the invention, scanned information is stored in one identification data center and reference information is stored in a different identification data center.

In another preferred embodiment of the invention, a portion of the scanned information is stored in one identification data center and another portion of the scanned information is stored in another identification data center.

A preferred embodiment of the invention, the system for providing security for on-line media comprises a media repository having media, an authorization user device, a media receiving unit, a communication system for transmitting media from the media repository to the authorization user device which transmits the media to the media receiving unit, a display device in communication with the media receiving unit for displaying the media, one or more sensors that operate to obtain scanned information, wherein the scanned information is transmitted in real-time to one or more identification data centers having databanks for storing reference information, and wherein the one or more data centers operate to make a comparison of the scanned information with the reference information and a determination is made if the individual viewing the media is an authorized individual, if a determination is made that the individual is not an authorized individual, the media repository directs (sends a command) to the authorization user device to stop sending the media to media receiving unit.

In another preferred embodiment of the invention, the media is streaming media.

In a preferred embodiment of the invention, the streaming media is a prerecorded video media.

In another preferred embodiment of the invention, the streaming media is a conference having one or more media repositories.

In a preferred embodiment of the invention the scanned data being transmitted to the one or more identification data centers is re-encrypted creating a virtual private network.

In a preferred embodiment of the invention, the one or more scanners are selected from the list comprising touch sensors, pressure sensors, flow and level sensors, light sensors, proximity sensors, smoke/gas sensors, tilt sensors, accelerometry sensors, humidity sensors, vibration sensors, movement sensors, sound sensors, metal detectors, temperature sensors, solar cell sensors, real time clock sensors, rain sensors, IR sensors, Grid-eye infrared array sensors, heartbeat sensors, PIR sensors, gyroscope sensors, flex sensors, water flow sensors, and ultrasonic sensors, radar, LiDAR sensors, skin sensors, height sensors, pulse sensors, antenna sensors, force sensors, cameras, photoelectric sensors, color sensors, magnetic sensors, orientation sensors, electric field sensors, scent sensors, biometric sensors, moisture sensors, and bone sensors.

In a preferred embodiment of the invention, the one or more sensors operate to take scanned information of an individual when the individual is positioned within a display viewing area for viewing media being displayed on the display device.

In another preferred embodiment of the invention, the one or more sensors operate to obtain scanned information of the display viewing area and the scanned information is transmitted to the one or more identification data centers and wherein the scanned information is used to make a determination if another individual has entered the display viewing area.

In a preferred embodiment of the invention, the one or more sensors operate to obtain scanned information of the display viewing area and transmits the scanned information to the one or more identification data centers and a determination is made as to if the authorized individual has left or entered the display viewing area and if the authorized individual has left the display viewing area the medial source or the media repository directs the authorization user device to stop transmitting the media.

In a preferred embodiment of the invention, the one or more sensors operate to obtain scanned information of the display viewing area and the scanned information is transmitted to the one or more identification data centers and a determination is made as to if there is an object capable or being used to transmit media to an unauthorized individual.

In a preferred embodiment of the invention the display device includes a display screen, a sound system and includes a processor that communicates with the one or more identification data centers to send scanned information to the one or more identification data centers and also operates to control the operation of the display screen and the sound system.

In a preferred embodiment of the invention, the display device is in the form of a headset.

In a preferred embodiment of the invention, the display device in in the form of a headset having a screen for displaying the media.

In a preferred embodiment of the invention, the system the display device is in the form of a headset for use by an authorized individual and includes one or more sensors and scanned information is transmitted to the one or more individual identification data centers and the scanned information is used to make a determination if an individual wearing the headset is an authorized individual.

In a preferred embodiment of the invention, the display device is in the form of a headset for use by an authorized individual and includes one or more sensors that operate to detect movement of the authorized individual.

In a preferred embodiment of the invention, the system display device is in the form of a headset for use by an authorized individual and includes one or more sensors that operate to obtain scanned information which is used to make a determination that other individuals are within the display viewing area.

In a preferred embodiment of the invention, the display device is in the form of a headset having a sound system that operates to allow an individual wearing the headset to hear audio without allowing other individuals not wearing the headset to hear the audio.

In a preferred embodiment of the invention, the display device is in the form of a head set or earphone having one or more sensors for obtaining scanned information and the scanned information is used to make a determination that the headset or earphone is in position on an individual.

In a preferred embodiment of the invention, the display device is in the form of a head set or earphone having one or more sensors for obtaining scanned information and the scanned information is used to make a determination that the headset or earphone is in position on an individual and that the individual is an authorized individual.

In a preferred embodiment of the invention, the display device is in the form of a head set or earphone having one or more sensors for obtaining scanned information, wherein the one or more sensors is a skin sensor and the scanned information is used to make a determination that the headset or earphone is in position on an individual.

In a preferred embodiment of the invention, the system includes one or more sensors that operate to obtained scanned information that includes an authorized individual's voice, and wherein the scanned information is used to make a determination as to the distance between the authorized individual and the one or more sensors.

In another preferred embodiment of the invention, the system includes one or more sensors placed within the display viewing area that operate to obtain scanned information and the scanned information is transmitted to one or more identification data centers and wherein a determination is made as to if an individual is within the display viewing area.

In another preferred embodiment of the invention, the system includes one or more sensors placed within the display viewing area that operate to obtain scanned information and the scanned information is transmitted to one or more identification data centers and wherein a determination is made as to the number of individuals within the display viewing area.

In another preferred embodiment of the invention, the system includes one or more sensors placed within the display viewing area that operate to obtain scanned information and wherein the scanned information is transmitted to one or more identification data centers and wherein a determination is made as to if an individual has entered or has exited the display viewing area.

In another preferred embodiment of the invention, the system includes one or more sensors placed within the display viewing area that operate to obtain scanned information which is transmitted to one or more identification data centers and a determination is made as to if an individual has entered or exited the display viewing area and if an individual has entered or exited the display viewing area the media being transmitted to the display device is paused or stopped.

In a preferred embodiment of the invention, the display device is in the form of a computer.

In a preferred embodiment of the invention, the display device in the form of a tablet or cellular telephone.

In a preferred embodiment of the invention, the display device in the form of a television or a large screen system.

In a preferred embodiment of the invention, the display device is in the form of a vehicle windshield.

Various other objects, advantages, and embodiments of the invention will be apparent from the following description, the accompanying drawings, and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a schematical representation of the system for receiving and display media having a media repository, a media receiving unit, a display device, one or more sensors and one or more individual identification data centers that cooperate through one or more communication systems to ensure that the individual viewing the media is an authorized individual;

FIG. 2 is a schematical representation showing a predefined display viewing area having a plurality of sensors that operate to obtain scanned information and scanned information is transmitted to the one or more individual data centers such that the scanned data is encrypted and stored in one or more databases for comparing with stored reference data;

FIG. 3 is a schematical representation of an identification data center having a data bank and a data analysis module having comparison software for comparing scanned information with reference information and a determination is made by the identification data center or the comparison is sent to the media repository for making a determination if the individual is an authorized individual;

FIG. 4 is a schematical representation of the media repository having a processor and a control unit for operating the administrative module and the transmitting/receiving module and is in communication with a memory having repository software that uses media and protocols stored in one or more repository databanks;

FIG. 5 is a schematical representation of a display device having a display screen, a sound system and a microphone device and one or more sensors for obtaining scanned information and showing the display device in communication with the media receiving unit;

FIG. 6 is a schematical perspective representation of a sound system for transmitting sound to an individual that utilizes conventional bone conducting technology that operates to transmit sound waves are converted into vibrations that are received directly by the Cochlea so the eardrum is not used. This sound system can also be integrated with one or more sensors (I.e., skin sensors) for more support for identification (Side note: This advance bone conducting technology [bone conduction is the conduction of sound [or the process by which sound waves travels through a medium] through the bones of the skull] will allow people/users to not only hear what they are streaming or listening to (including via Bluetooth and RFID), but they will be able to use these type of headphones as a way to identity that they are “human” when they respond to a security system such as a “Specification System”, a system that identifies everyone in a room and it's environment (e.g., in a special room that is in a Federal government building) and a system that may ask the person to repeat their name. Such a system will need to monitor where the sound came from and by whom the sound is coming from. For instance, such a system might say, “Repeat after me, My name is . . . (e.g., Devin Randolph) I am from . . . (e.g., Ohio)” The system will see that the sound is coming from a human being, who is present by the use of a skin-worn sensor (which can be but is not limited to being able to measure the pulse and rate of respiration through detection of the expansion and contraction of the skin or it could be utilized by a sweat sensor that is placed onto the skin). These types of advanced headphones essentially help to detect that the sound is not only coming from a certain area, but a certain human being (with the help of the skin sensors), thus reducing or helping in the process of eliminating deep fake scams. These headphones have more than one version, for instance one version will have the skin conduction technology located at the temples, because the pulse you feel in the temples comes from your superficial temporal artery which is a branch of your external carotid artery: this a good placement for skin sensors or skin sensor like structures. You can also attach/connect these advanced headphones' skin technology to your phone; this data can digitally be sent to your phone as well; all data from these headphones are sent and stored in a data center. The bone conducting process is there to identify where the sound is coming from and by whom [speech recognition]. These types of headphones can be integrated with but not limited to televisions, phones, vehicles [e.g., car windshield technology], various types of display units and more. The wiring or inside of the phone can utilize graphene [e.g., graphene electrode]. Individuals can download an app to their phone to control the volume or they can control the volume through their charging port, or through voice command [microphone (a microphone plug in [attachment]) can be made or integrated as well] or through a viable electronic-skin motion sensor or other various sensors. The hardware/headsets can also utilize processors [e.g., micro] for additional technical support.);

FIG. 7 is a perspective view of a display device in the form of a headset having a frame and a display screen mounted to the frame for placing the display screen in front of the eyes of the individual wearing the headset and one or more scanners positioned on the frame and a transmitter that operates to transmit scanned information to one or more identification data centers;

FIG. 8 is a schematic front view of the display device of FIG. 7 in the form of a headset;

FIG. 9 is a perspective view of the display of FIG. 7;

FIG. 10 is a top schematical perspective representation of a display device in the form of a computer showing one or more sensors mounted on the frame of the computer and operate to obtain scanned information for transmitting to one or more identification data centers;

FIG. 11 is a bottom schematical perspective representation of the display device of FIG. 10 in the form of the computer showing a sensor positioned on the base portion of the frame;

FIG. 12 is a bottom planar view of the display device of FIG. 10 showing a plurality of sensors positioned on the base portion of the frame;

FIG. 13 is a front view of the display device of FIG. 10 showing a display screen and one or more sensors positioned along the frame;

FIG. 14 is a schematical perspective representation of a display device in the form of a tablet having a frame and a display screen and one or more sensors positioned along the frame which operate to obtain scanned information which is transmitted to one or more identification data centers;

FIG. 15 is a front schematical view of the display device of FIG. 14, showing the frame, the display screen and a plurality of sensors;

FIG. 16 is a front schematical view of the display device in the form of a television or movie screen showing the frame, the display screen and a plurality of sensors and placed on a sensor array having one or more sensors for obtaining scanned information for transmitting to one or more identification data centers;

FIG. 17 is a schematical representation of the back side of the display device of FIG. 16 showing the display device positioned within a sensor array for obtaining scanned information which is transmitted to one or more identification data centers;

FIG. 18 is a schematical representation of a display device having a large display screen, such as a device for use in a conference room or movie theater, having one or more sensors that cooperate with other sensors positioned around the display viewing area (FIG. 2) for use in determining the number of individuals within the display viewing area and/or if there is a media recording device in operation within the display viewing area;

FIG. 19 is a schematical representation of the back side of the display device in the form of a cellular telephone showing a frame and a display screen and one or more sensors positioned along the frame;

FIG. 20 is a schematical representation of the front side of the display device of FIG. 19 in the form of a cellular telephone showing one or more sensors positioned along the frame;

FIG. 21 is a schematical representation of a display device in the form of a vehicle windshield having a display screen having one or more sensors positioned around the circumference of the display screen;

FIG. 22 is a schematical representation showing a preferred embodiment of the system of the subject invention whereby an individual places a display device in the form of a headset or earphone on the individual and a sensor on the earphone or headset is in the form of a skin sensor that operates to obtain scanned information of the individual and transmits the scanned information to an identification data center which then operates to transmit an instruction to the individual requesting identification information which is transmitted to the identification data center which compares the identification information with reference information to determine if the individual is an authorized individual; and

FIG. 23 is a schematical representation showing another preferred embodiment of the system of the subject invention showing a portable display device connected to a portable authorization user device that is connected to one or more identification data centers, such as through the Internet, whereby the media receiving unit is in the form of a mobile receiving unit having a display device and a camera system that operates to take a real time image of an individual using the mobile receiving unit and transmits the real time image to the portable authorization user device that then transmits the real time image to the one or more identification centers for confirming that the individual is an authorized individual.

### BEST MODE FOR CARRYING OUT THE INVENTION

The subject invention is a system and method that provides security for receiving and displaying media. Unlike prior art security systems, the method and system of the subject invention for providing security for receiving and viewing media, such as on-line streaming media, operates to provide security for the software and the devices used in the transmission and display of such media and also provides security for the transmission and viewing of media when being displayed for use by an authorized individual. The system and method of the subject invention further operates to ensure that only an authorized individual or individuals are able to view the media. The system and method of the subject invention operates such that media being displayed to an authorized individual is protected from the point that the media is transmitted from a media repository or media source to a media receiving unit and ensures the media source than only authorized individuals are viewing the transmitted media, but also protects the authorized individual that the media being displayed is not being observed by unauthorized individuals.

As used herein, the term “media” includes (both visual and sound) television shows, live broadcasts, taped broadcasts, streaming and on-demand programming, satellite transmissions, conferences (such as SKYPE transmissions, MICROSOFT TEAM meeting transmissions, and the like), concerts webinars, podcasts, photos, graphs, games, avatars, data, tests, documents and other viewable material, and the like. As used herein, the term “communication system” includes the Internet, satellite systems, cable systems, telephone systems, television and radio transmission systems, fiber optic systems, microwave systems, asynchronous transfer mode systems, digital subscriber line systems, cellular systems, and private networks. As used herein, unless otherwise stated, a “display device” includes systems for receiving media and operate to permit an individual to view (and/or listen to media) and include, but not limited to, televisions, movie systems, concerts, computers, tablets, headsets, helmets, gaming systems, watches, windshields and display units. As used herein a “display screen” includes a device that operates to display media (and otherwise stated, has a sound system for listening to media) and includes, but not limited to, television screens, computer screens, movie screens, watch screens, screens on helmet and headsets, avatar system screens, phone display screens, screens used for gaming systems, display units, tablet display screens, and windshields having display capabilities. As used herein the term “authorized individual” means an individual that is registered in the subject security system as being permitted to receive and view the particular media being transmitted to a defined location (display viewing area). It should be understood that an “authorized individual” can be only one particular individual or can be a multiple number of individuals. The term “unauthorized individual” is any individual that is not authorized to view media being transmitted to a display viewing area. As used herein the term “media source” can be the source of the media being stored in a media repository, such as a film company, or it can be the source of the media, which may or may not be stored in a media repository, such as a conference meeting being transmitted. As used herein the term “media repository” can be a source of pre-recorded media, or a source of real-time media (such as, but not limited to, a live event such as a sports event or a conference (having one or more individuals participating in a conference), gaming, documents, data, graphs, photos, tests, social media content, class rooms, and other such forms). Thus, a “media source” and a “media repository” may be the same entity or may perform the same or similar functions, such as supply media to various media receiving units owned or used by individuals that cooperate with a display device for displaying the media. As used herein the term “display view area” can include a room (such as an office, a room in a building, a conference room and the like), a school room, an auditorium, an area within a room, a cubical, the passenger compartment of a motorized vehicle, or can include an area immediately adjacent to an authorized individual viewing media on a display device and also includes an area whereby an individual is able to view media being viewed on a display device. As used herein, unless otherwise stated, the term “sensor” or “sensors” refers to pressure sensors, touch sensors, flow and level sensors, light sensors, proximity sensors, smoke/gas sensors, tilt sensors, accelerometry sensors, humidity sensors, vibration sensors, movement sensors, sound sensors, metal detectors, temperature sensors, solar cell sensors, real time clock sensors, rain sensors, IR sensors, Grid-eye infrared array sensors, heartbeat sensors, PI R sensors, gyroscope sensors, flex sensors, water flow sensors, and ultrasonic sensors, radar, LiDAR sensors, skin sensors, height sensors, pulse sensors, antenna sensors, force sensors, cameras, photoelectric sensors, color sensors, magnetic sensors, orientation sensors, electric field sensors, scent sensors, moisture sensors, and bone sensors, which can be used individually or in combination with various types of sensors. Unless otherwise stated herein, “scanned information” can be any information or data obtained from one or more sensors or can include information inputted by an individual, such as a password or other inputted information, such as address information, birthdate information, social security information, and other such information that can be used for identifying the individual or for use in determining if the individual is an authorized individual.

### Methodology

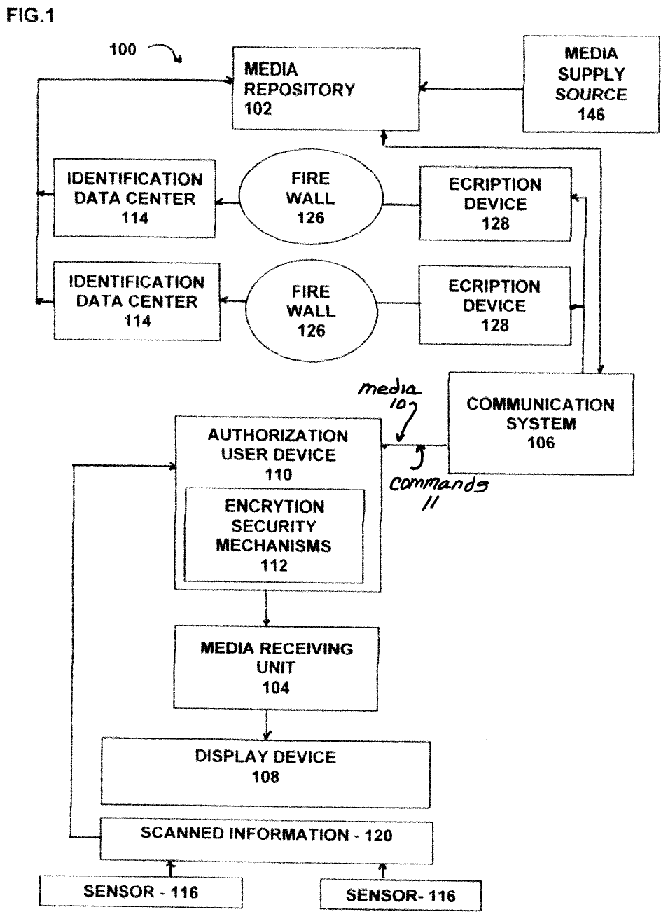

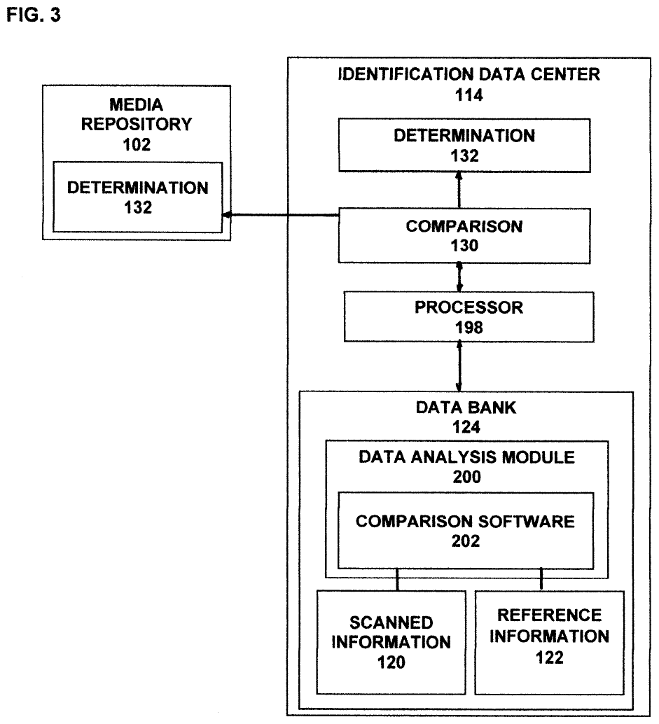

Referring to FIG. 1, a schematical representation of the security system for receiving and viewing media 100 is shown having a media repository 102 for receiving and/or storing media 10 (FIG. 3). The media repository 100 is communicatively coupled to a one or more media receiving units 104 that operate to receive the media being transferred from the media repository 102 through a communication system 106 and operates to transfer the media to one or more display devices 108 that function to display the media for viewing by an authorized individual 12 (FIG. 3). The transfer of the media from the media repository 102 to a media receiving unit 104 utilizes a secure media delivery method. Such methods of providing security for the transmission of media (including media or other types of data or information) through the communication system (“security mechanisms”) include, but is not limited to, an AES encryption (“Advanced Encryption Standard”) process of encoding information so that only an authorized individual(s) can view the media; a HTTPS process that wraps the media between the media repository and the receiving unit in a layer of secure encryption; an SSL/TLS encrypted paywall method; a password method that places a password on the media and requires an individual to enter the password in order to watch the media; an IP restriction method that uses a allows only media to be transferred to certain IP addresses.

As further illustrated in FIG. 1, the system 100 further includes an authorization user device 110 that operates to receive media and other information being transmitted through the communication system 106 and to transmit information, such as scanned information, through the communication system 106 (preferably uses conventional encryption security mechanisms 112 (as identified above) for transmitting the information in an encrypted format through the communication system) to an identification data center 114 or to other locations and is electronically connected to the media receiving unit 104. The authorization user device 110 further communicates with the media repository 102 through the communication system 106 for use in authentication that the individual wanting to view the media being transferred to the media repository for displaying on the display device 108 is an authorized individual who is authorized to view the particular media. In operation, an individual wishing to view the media uses an input device (not shown) in communication with the authorization user device 110 to input information (scanned information), such as a password, which is then communicated to the media repository 102 that operates to use the password and to communicate with the media repository 102 for establishing authorization for an individual to view the particular media (authorized individual). It will be understood, as described herein below that other user information (such as the identity, address, birth date information, account number and the like) for use in authorizing an individual to view media can also be utilized. The authorization user device 110 also cooperates with the media receiving unit 104 to ensure that only authorized individuals can view the media. In operation, the authorization user device 110 receives media 10 and/or commands 11 from the media repository 102 (or media supply source 146). As will be described herein, if the individual wishing to view the media is an authorized individual, the authorization user device will transmit the media to the media receiving unit which will transmit the media to the display device for viewing by the authorized individual. If the individual wishing to view the media is not an authorized individual, the media repository or the media supply source will transmit a command to the authorization user device to stop the transmission of the media to the media receiving unit. Accordingly, the authorization user device cooperating with the media source ensures the media repository (media source) that only authorized individuals can view the media (for example only individuals that have paid to view the media).

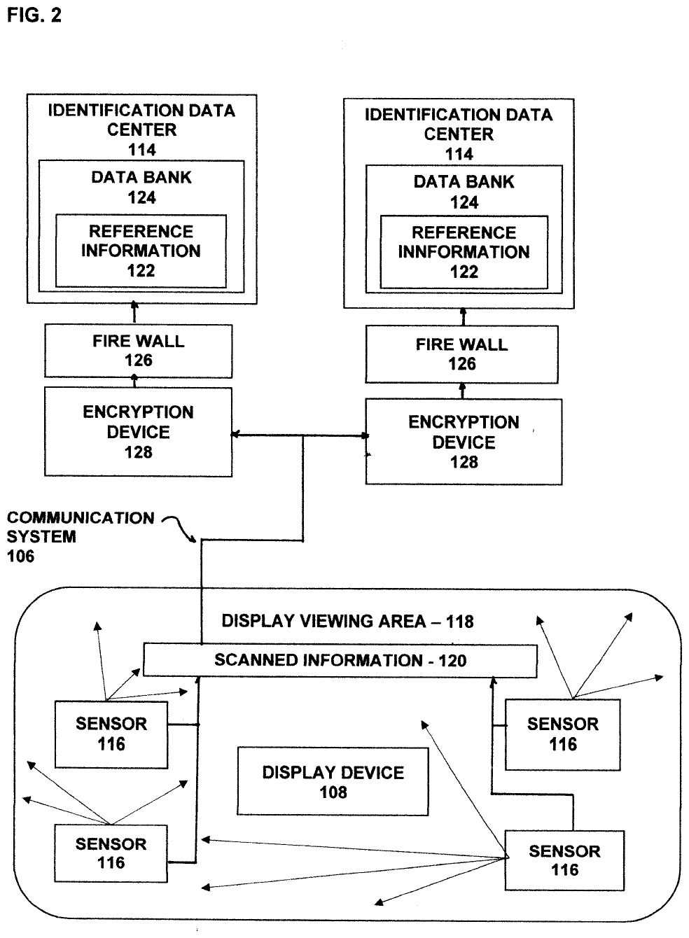

Referring to FIGS. 1 and 2, in a preferred embodiment of the invention, the system 100 includes one or more sensors 116 placed within the display viewing area 118 that operate to collect scanned information 120 and are electronically (such as by cable or wireless connections) connected to the authorization user device 110 then operates to transmit the scanned information 120 through the communication system 106 to one or more identification data centers 114 that operate to compare the scanned information 120 with reference information 122 stored within one or more data banks 124 of the identification data centers 114 to determine if an individual within the predefined display viewing area 118 is an authorized individual 12. As illustrated, the scanned information 120 is transmitted through one or more communication systems 106 that use security mechanisms 112 to ensure the security of the scanned information 120. In a preferred embodiment of the invention, the one or more identification data centers 114 are each protected by a fire wall 126 and an encryption device 128 that encrypts the already encrypted scanned information creating re-encrypted scanned information which is then transmitted to the one or more identification data centers 114 for storage in the data banks 124. Accordingly, scanned information that is transmitted from the authorization user device to the one or more identification data centers is encrypted and then re-encrypted before it is received in the one or more identification data centers and stored thereby making it significantly more difficult for someone to intercept and obtain or modify the scanned information. Preferably, each type of scanned information 120 is stored at separate and independent identification data centers 114 thereby making it significantly more difficult for someone to intercept and “hack” into the system. For example, scanned information collected on an individual user, such as scanned information from an eye scan or a scanned information from a fingerprint sensor may be saved at one identification data center and scanned information collected for a display viewing area, such as motion scanned information or thermal scanned information, may be saved at a different identification data center. As illustrated in FIG. 3, once the scanned information 120 is received in the one or more identification data centers 114, the one or more identification data centers 114 operate to compare the scanned information 120 with reference information 122 such as, but not limited to, an eye scan or fingerprint scan or a facial scan or a voice scan previously taken of the authorized individual. Comparisons 130 are then used by the one or more identification data centers 114 to make a determination 132 (or the comparisons are sent to the media repository to make a determination), if the individual wishing to view or is viewing the media being displayed on the display device 108 is an authorized individual or is not an unauthorized individual. If the determination 132 concludes that the individual is not an authorized individual, the media repository 102 then operates to transmit a command 11 to the authorization user device 110 to stop transmitting the media to the media receiving unit 104.

### Media Transmission

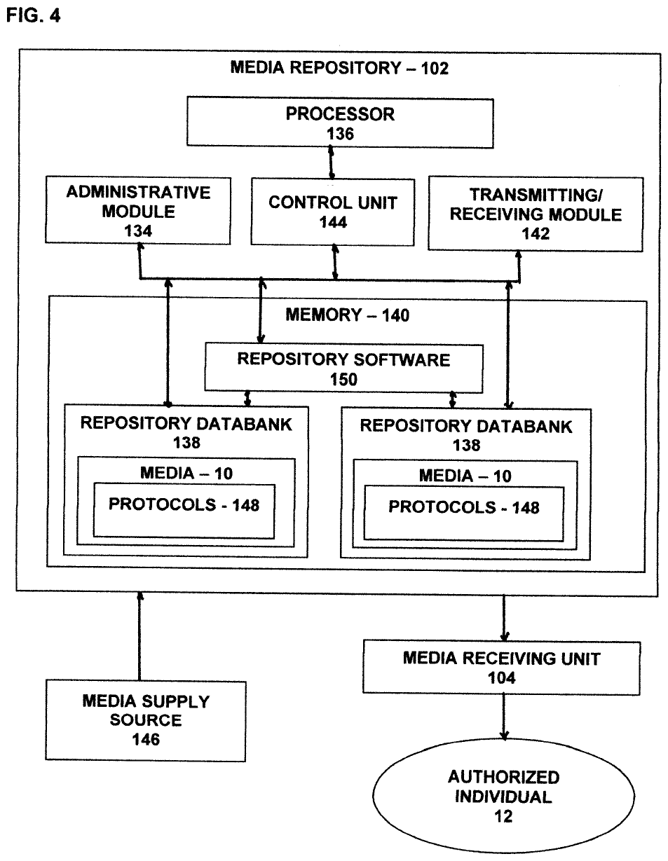

Referring to FIG. 4, the media repository 102 comprises an administrative module 134 that operates using a processor 136 that interacts with one or more repository data banks 138 within a memory 140 and with a transmitting/receiving module 142 that operates with a control unit 144 for controlling the operations of the media repository 102. Together, the administrative module 134 and the transmitting/receiving module 142 operate to permit an authorized individual 12 to request that certain media 10 be transmitted to the media receiving unit 104 being used by the authorized individual 12. In a preferred embodiment, the administrative module 134 further operates to receive media 10 from various media supply sources 146 and stores the media 10 in the one or more repository data banks 138. In a preferred embodiment, the media 10 stored within the one or more repository data banks 138 include protocols 148, that can include, but not limited to, a listing of authorized individuals that can have access to the media, times that the media can be accessed, locations that can receive transmitted media, security (such as passwords) required to access the media, and other protocols required for receiving the media. Such protocols 148 are used by the administrative module 134, such as to approve a request to review media, such as a request by an individual to the media repository to access media or used by the administrative module in transmitting or not transmitting media to a particular media receiving unit.

The administrative module 134 includes repository software 150 operated by the processor 136 and stored within the memory 140 and is a computer-readable medium having computer-readable instructions for performing a method of receiving and transmitting media under the various protocols 148 and is an interactive, menu and event driven system that operates to create conventional prompt, dialog, and entry windows on the display device or media receiving unit to guide an individual in requesting certain media to be transmitted to the media receiving unit 104 being used by the individual. Thus, the repository software 150 operates to provide an interactive communications interface for facilitating communications and information exchange between the media repository and an individual requesting a particular media As used herein, it should be understood that the term “software” refers to any form of programmed machine-readable language or instructions (e.g., object code) that, when loaded or otherwise installed, provides operating instructions to a machine capable of reading those instructions, such as a computer. The repository software 150 of the present invention can be stored or reside on the memory 140 used by the media repository 102. Software used in the subject system can as be loaded or installed from, one or more floppy disks, CD ROM disks, hard disks or any other form of suitable non-volatile electronic storage media. Software can also be installed by downloading or other form of remote transmission, such as by using Local or Wide Area Network (LAN or WAN)-based, Internet-based, web-based or other remote downloading or transmission methods. It should be understood that the repository software 150 can also interact with and operates in cooperation with the various device software installed in the various components of the system, such as software installed in the receiving units, display devices, authorization user devices, and the identification data centers to permit the transmittal of information and/or media between the various components.

As shown, the media repository 102 uses the administrative module 134 and the transmitting/receiving module 142, which work together, to provide an interface between the media repository 102 and authorized individuals 12 utilizing their respective input/output devices, for electronically inputting information and receiving media for viewing as will be described herein below.

### Media Displaying

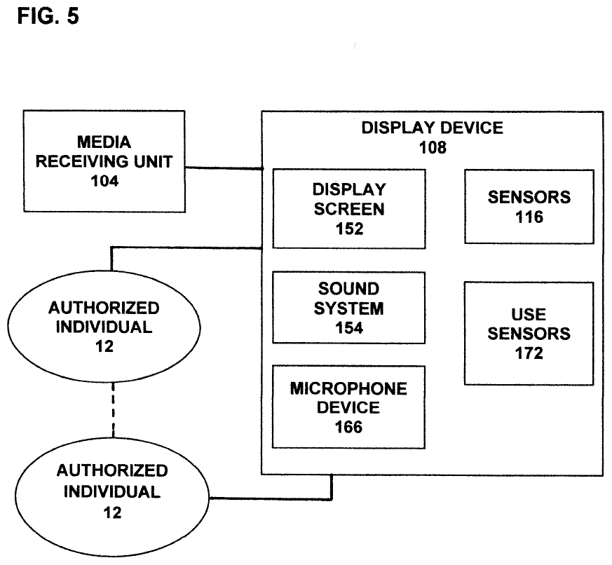

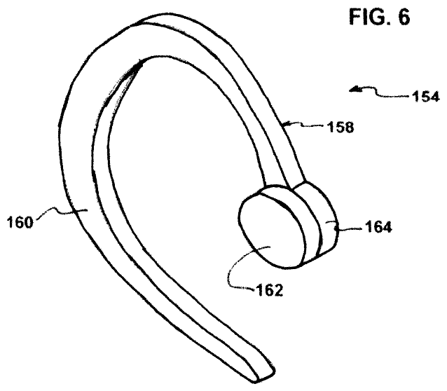

As schematically illustrated in FIG. 5, a preferred embodiment of a display device 108 is shown electronically connected to the media receiving unit 104 for receiving media for viewing. The display device 108 includes a display screen 152 that operates to display the visual portion of the media and a sound system 154 that operates to play the audio portion of the media. As shown in FIG. 6, in a preferred embodiment the sound system 154 is in the form of an earphone or speaker 158 for transmitting sound to the ear of a user. In a preferred embodiment, as shown, the earphone 158 utilizes conventional bone conducting technology that operates to transmit sound waves are converted into vibrations that are received directly by the Cochlea so the eardrum is not used. Thus, “sound” reaches the ears as vibrations transferred directly through the bones forming the skull of the authorized individual. It should now be understood that the use of such bone conducting technology substantially reduces the likelihood that the audio portion of the media is not heard by an unauthorized individual. As illustrated, the sound system 154 includes an ear wire 160 for looping around the ear of the user and includes a BLUETOOTH chip and a place to connect or integrate other sensors (E.g., skin sensors) 162 for receiving an audio media transmission and a sound waver transmitter 164 that receives the audio transmission from the chip 162 and operates to convert the sound waves into vibrations and is places such that the vibrations are received directly by the Cochlea.

In a preferred embodiment of the invention, as illustrated in FIG. 5, the display device 108 also includes a microphone device 166 that operates to permit the user to transmit sounds (such as by his or her voice) to the media repository or to other authorized individuals receiving media. In another preferred embodiment of the invention, the sound system 154 operates to receive audio communications from other authorized individuals. For a non-limiting example, an authorized individual watching the media being displayed can communicate with other authorized individuals watching the media using the microphone device and the sound system through the system 100 (or in a preferred embodiment by use of a wireless connection such as by BLUETOOTH) so that they can communicate with each other while the media is being viewed.

### Display Device—Headset Configuration

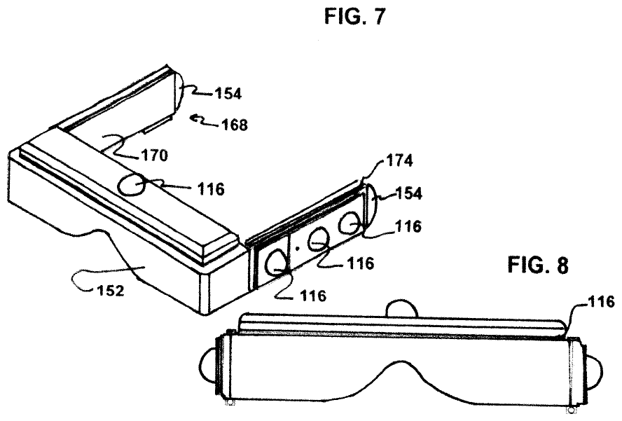

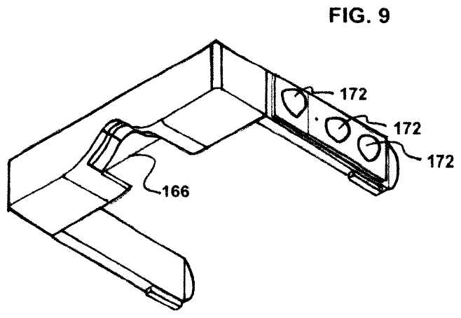

In a preferred embodiment the display device 108, as illustrated in FIGS. 7-9, is in the form of a headset or eyewear 168 (referred to as “headset”) that can be worn by an authorized individual. The headset 168 includes a frame 170 adapted to hold a display screen 152, such that the display screen is positioned at an optimum distance in front of the eyes of the authorized individual. Such display screens may include liquid-crystal display (LCDs) screens, light emitting diode (LED) screens, organic LED (OLED) screens, or any other suitable types of screens capable for viewing media. It should also be understood that the display screen may include a single screen for viewing by both eyes or separate display screen for each eye. The frame 170 includes a microphone device 166 that operates to permit the user to transmit sounds (such as by his or her voice) to the media repository 102 or to other authorized individual receiving media. In another preferred embodiment of the invention, the frame 170 includes a sound system 154 that preferably utilizes conventional bone conducting technology positioned such that that it operates to transmit sound waves to one or both ears by converting the sound waves into vibrations that are received directly by the Cochlea so the eardrum is not used. It should be understood that the sound system 154 using bone conducting technology can also be used as a microphone device 166. The frame 170 further includes one or more use sensors 172, such as, but not limited to, heat sensors, pressure sensors, and other forms of sensors that operate to sense if an individual has placed the display device in position of the head of an authorized individual or has removed the display device. A processor 174 within the frame 170 is electronically connected to the one or more use sensors 172 and to the media receiving unit 104 which transmits the scanned information 120 to one or more identification data centers 114. The one or more identification data centers 114 then operate to make a comparison 130 of the scanned information 120 to reference information 122 for use in making a determination 132 if the authorized individual has removed the display device 108. In the event the authorized individual has removed the display device, upon receiving the comparison 130 (such as, but not limited to a comparison showing a pressure change), from one or more identification data centers 114, the media repository 102 operates to end (or pause) the transmission of the media to the media receiving unit 104 until the individual replaces the display device 108 (headset) in position and the individual is again identified as an authorized individual 12. It should be understood that transmission of media to the display unit can be by way of direct transmission, such as by wire or cable, or transmitted by a wireless system, such as by a BLUETOOTH connection. Preferably, power to the display screen 152, the microphone device 166, use sensors 172, sound system 154 and other systems on the display device 108 is provided by one or more batteries mounted to or within the frame 170. Such batteries can include, but are not limited to, lithium-ion batteries, lithium-polymer batteries, primary lithium batteries, alkaline batteries and the like. It should also be understood that power could be provide by an external power source connected using wires or cables. In a preferred embodiment, a sensor 116, such as a camera or heat sensor, may be located on the frame 170 such that it can detect an individual positioned around and behind the individual using the headset 168 and operates to transmit the scanned information 120 to one or more identification data centers 114 that cooperates with the media repository to stop transmission of the media until the detected individual moves to a location whereby that individual cannot see the media being displayed on the display screen.

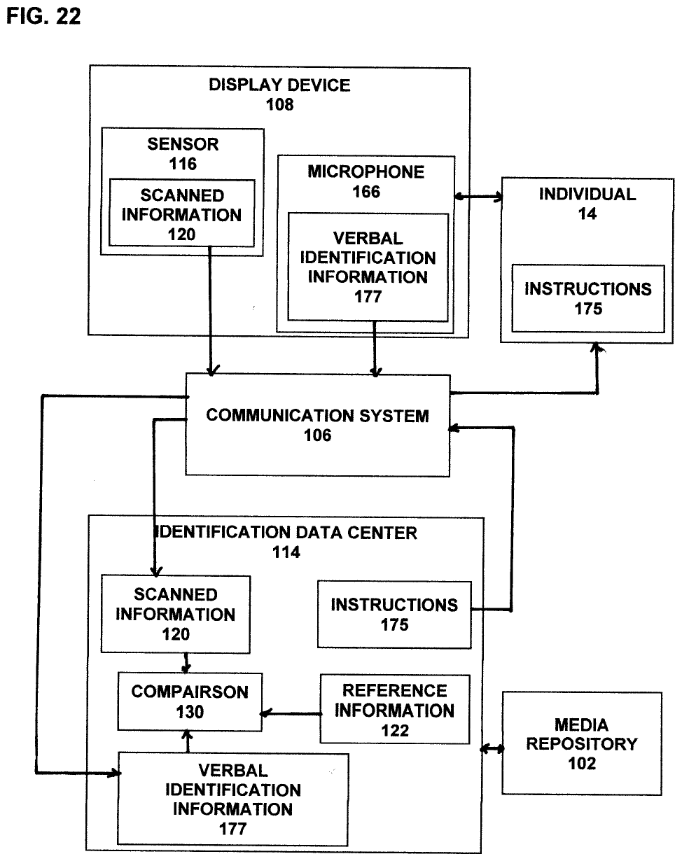

In another preferred embodiment, the display device 108 in the form of a headset 168 or earphone 158 includes a sensor 116, in the form of a skin sensor, such as described in U.S. Pat. No. 10,635,868, which is incorporated herein in its entirety, to detect that an individual is wearing the display device 108 (earphone 158 or headset 168). In operation, as illustrated in FIG. 22, when an individual places the display device 108 into position on the individual 14, the sensor 116 obtains scanned information 120 which is transmitted to an identification data center 114 which then operates to generate and transmit an instruction 175 through the communication system 106 to the authorization user device 110 that transmits the instructions 175 to the individual 14 using the sound system 154 requesting the individual 10 to identify themselves (such as by stating the individual's name, social security number or other verbal identification information) using the microphone device 166 which is then transmitted back to the authorization user device 110 and to the identification data center 114 as verbal identification information 175. It should be understood that the instructions 175 can be generated by the identification data center 114 using an artificial intelligence system (AI) that generates specific instructions based on the individual 114. The identification data center 114 then makes a comparison 130 of the verbal identification information 177 to reference information 122 and uses the comparison 130 to ensure the individual 14 is an authorized individual 12 and that the identified authorized individual 12 is the “real individual” wearing the display device 108. It should now be apparent that by using such scanned information and verbal identification information, ensures that the identified authorized individual is a “real individual” operating in real-time wearing the display device and not a voice recording or a false image, such as a photograph or fingerprint. It should also be understood that by using bone conducting technology, rather than use of earphones or ear plugs provides a benefit in allowing the individual to hear media transmissions with little or no impact in allowing the individual to hear outside noises, such as people entering into the area or other sounds. Further, the described system using bone conducting technology allows only the wearer to hear sounds (such as a media transmission), while allowing the wearer to hear outside sounds.

As illustrated is FIG. 2, one or more sensors 116 are placed within the display viewing area 118 and operate to obtain scanned information 120 which is transmitted to one or more identification data centers 114 that function to compare the scanned information 120 with reference information 122. As illustrated, various types of scanners, operate to provide scanned information 120 that detect the presence of an individual within the display viewing area 118 and are strategically placed such that an individual in the display viewing area 118 would be detected and the scanned information 120 is transmitted to the one or more identification data centers 114. Once the scanned information 120 is received in the one or more identification data centers 114, the one or more identification data centers 114 makes a comparison 130 using the scanned information 120 and the reference information 122. The one or more identification data centers 114 either makes a determination 132 that an individual is present in the display viewing area 118 or transmits the comparison 130 to the media repository 102 that uses the comparison 130 and makes a determination 132 that an individual has entered into the display viewing area 118. If the determination 132 is that this individual is “new” to the display viewing area 118, the system 100 operates to authenticate that this individual is an authorized individual. If the individual is not an authorized individual, the media repository 102 operates to stop transmitting the media to the media receiving unit 104, such as by transmitting a command to the authorization user device. It should now be understood that the one or more sensors operate to provide a continuous stream of scanned information to the one or more identification data centers or operate to provide a sequence of scans taken at random or predetermined times (scanned information) and which are sent to the one or more identification data centers. In another preferred embodiment of the invention, the system 100 includes one or more sensors 116 placed within the display viewing area 118 that operate to obtain scanned information 120 which is then transmitted to one or more identification data centers 114 that operate to make a comparison 130 of the scanned information 120 with reference information 122 and transfers the comparison 130 to the media repository 102 that operates using the comparison to make a determination 132 as to the number of individuals within the display viewing area 118. For a non-limiting illustration, if the scanned data shows additional thermal images or sounds or motion that were not present in the reference information, a determination would be made that there are additional individuals within the display viewing area. If the number of individuals within the display viewing area, for example, exceeds the number of authorized individuals permitted to be in the display viewing area, the media repository operates to stop or pause the transmission of the media to the media receiving unit. The media repository then operates to begin the authorization process for each individual within the media viewing area to ensure those individuals within the media viewing area are all authorized individuals. Further, in another non-limiting illustration, using the comparison a determination can be made as to if an individual has entered or exited the display viewing area, and if an individual has entered the display viewing area, the transmission of the media is stopped until the individual entering the display viewing area has been identified as an authorized individual or leaves the display viewing area.

### Display Device—In Form of a Computer or Tablet:

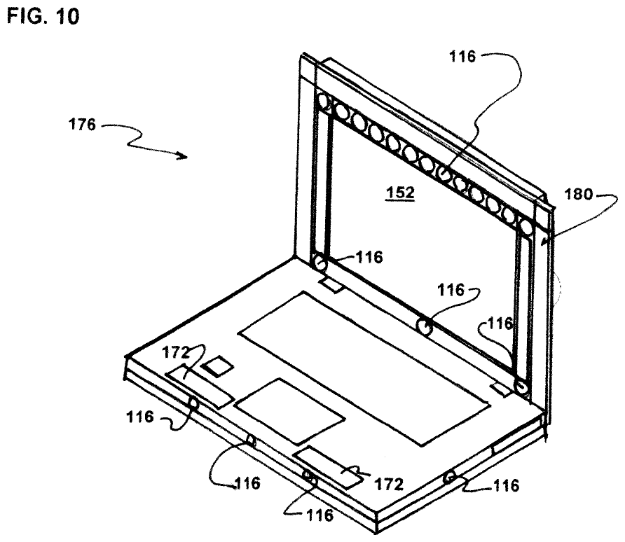

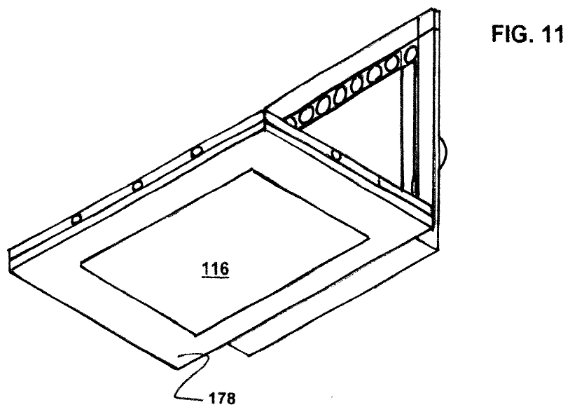

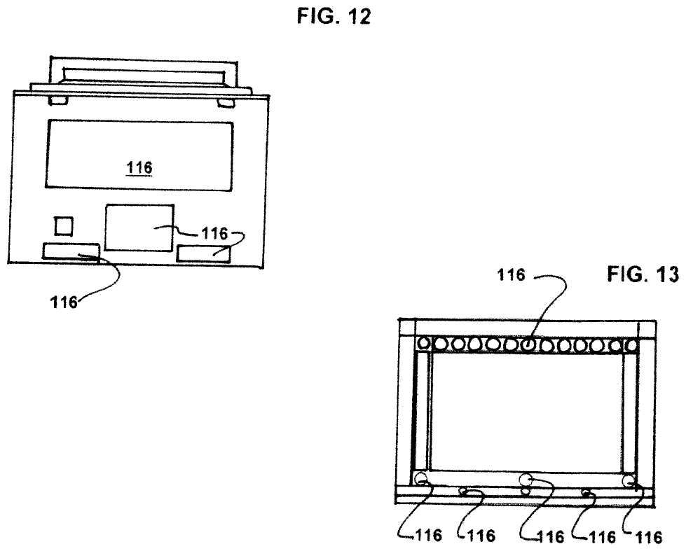

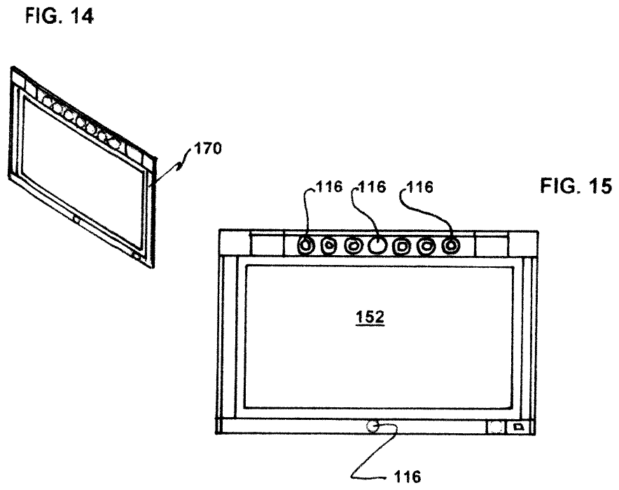

In another preferred embodiment, as illustrated, the display device 108 is in the form of a computer 176 (FIGS. 10-13) or tablet (FIGS. 14-17). The computer 176, as shown, is in the form of a laptop computer and includes a base 178 and a display screen 152 mounted to a frame 180. The frame 180 and/or the base 178 includes one or more sensors 116 that operate to obtain scanned information 120 of the display viewing area 118 which is transmitted to the one or more identification data centers 114 as described above. In a preferred embodiment, the base 178 includes a sensor 116, such as a pressure sensor or a vibration sensor, that operates to obtain scanned information 120 that can be used to determine if the laptop computer has been moved. It should be apparent that such sensors can be placed on the base of a display screen (such as a computer monitor) for display devices that comprise individual (not attached) components. It should also be understood that sensors positioned on the frame and/or of the display device, as shown, can also be used by the identification data center to identify the number of individuals within the display viewing area, to identify if an individual enters or leaves the display viewing area, and to determine if an authorized individual viewing media leaves the display viewing area. Further, it should be understood that the scanned information obtained from the sensors on the frame and/or base of the display device can be used to determine if the display device is moved, and if so, can be used to make a determination that the transmission of the media to the display device should be paused or stopped. In another preferred embodiment, the display device 108 in the form of a computer can also have one or more use sensors 172 that operate to collect scanned information for use in identifying the individual wishing to view of viewing the media. It should also be understood that the computer can be connected to the media receiving unit 104 and the authorization user device 110 wirelessly. However, it should be understood that the computer can be also connected by wire to the media receiving unit and the authorization user device. It should also be understood that the media receiving unit and the authorization user device can be incorporated into the control system (processor and memory and receiving and transmittal system of the computer).

As shown in FIGS. 14-17 the display device is in the form of a tablet having a display screen 152 supported by a frame 170. One or more sensors 116 are positioned along the frame 170 for obtaining scanned information 120. The tablet is preferably connected to the media receiving unit 104 and the authorization user device 110 wirelessly. However, it should be understood that the tablet can be connected by wire to the media receiving unit and the authorization user device 110. It should also be understood that the media receiving unit and the authorization user device can be incorporated into the control system (processor and memory and receiving and transmittal system of the tablet). In another preferred embodiment, as illustrated in

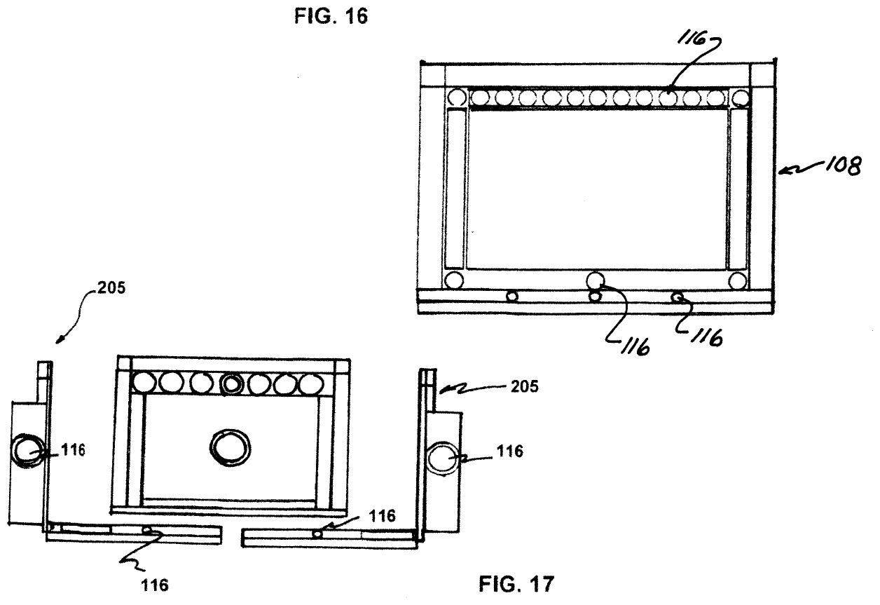

FIGS. 16 and 17, the tablet can be mounted on a support frame 205 for supporting the tablet in an upright position for viewing media. As shown additional sensors 116 can be attached to the support frame which operate to provide more coverage of the display viewing area for determining if other individuals enter the display viewing area.

### Display Device—Television Configuration or Large Screen Display Devices

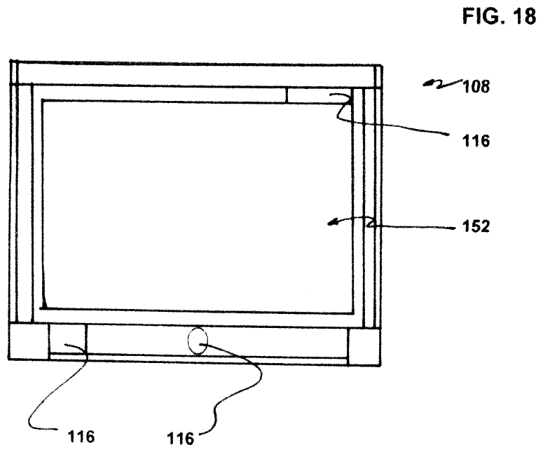

In another preferred embodiment, as illustrated in FIGS. 2 and 18, the media display device 108 is in the form of a television or a large screen display device (such as used in a class room, conference room, movie theater, and the like) that receives media being transmitted by the media repository 102 through the communication system 106 and includes a display screen 152 for displaying media. As illustrated, in one preferred embodiment, one or more sensors 116 are strategically placed within the display viewing area 118 and around the display device 108 and operate to transmit scanning information 120 to one or more identification data centers 114 that function to make a comparison 130 of scanned information 120 with reference information 122 and transmits the comparison 130 to the media repository 102 that functions to make a determination 132 as to the number of individuals within the display viewing area 118. It should be understood that the number of scanners, the type of scanners and the location of the scanners is easily determined by one skilled in the art by determining the level of security to be achieved and the size and layout of the display viewing area. Once the scanned information 120 is received in the one or more identification data centers 114, the one or more identification data centers 114 makes a comparison 130 of the scanned information 120 with reference information 122 and can operate to make a determination 132 (or send the comparison to the media repository to make a determination) if the number of individuals present in the display viewing area 118 exceeds the number of individuals authorized to view the media. It should now be understood that the one or more sensors can operate to provide a continuous stream of scanned information to the one or more identification data centers or can operate to provide a sequence of scans taken at random or predetermined times and the scanned information is sent to the one or more identification data centers. If the number of individuals within the display viewing area 118 exceeds the number of individuals permitted to be in the display viewing area 118, the media repository operates to stop or pause the transmission of the media to the media receiving unit, such as by sending a command to the authorization user device. The media repository then operates to begin the authorization process for each individual within the media viewing area to ensure those individuals within the media viewing area 114 are all authorized individuals or, such in the case of the display device being a large screen, such as a movie theater, the media is stopped until the number of individuals within the display viewing area equals to or is less than the number of individuals authorized to view the media.

### Display Device—Cellular Telephone

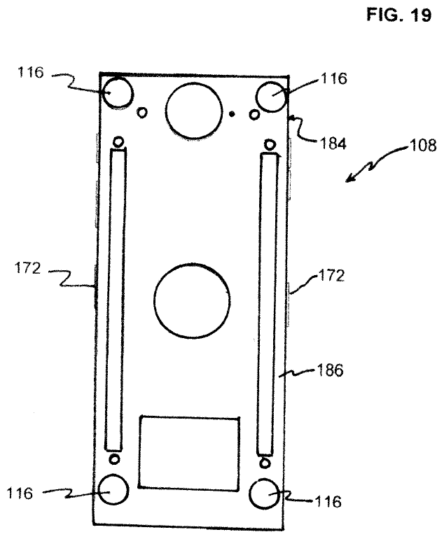

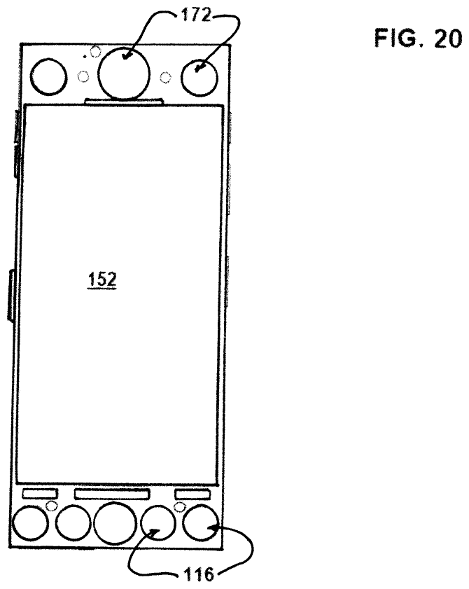

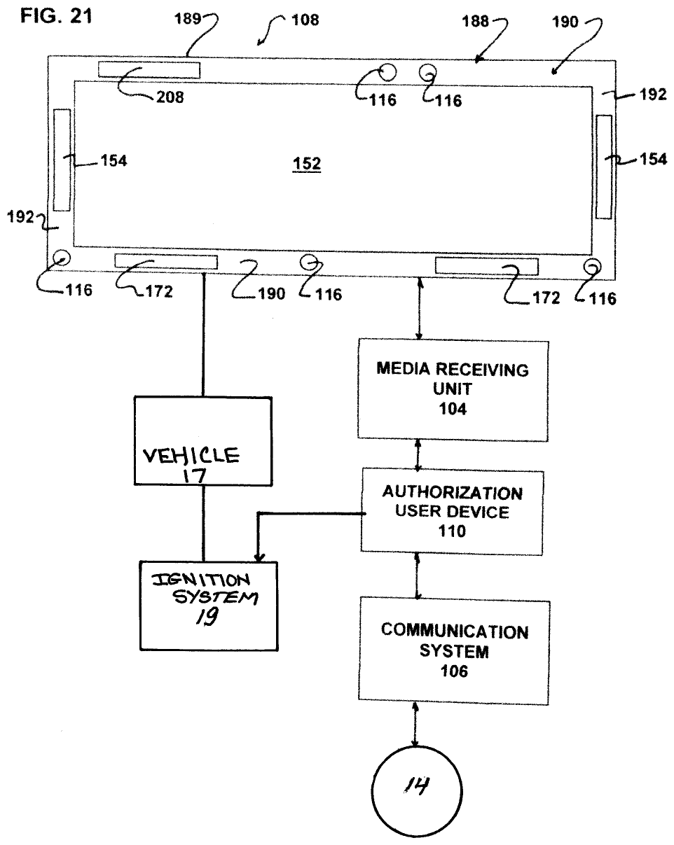

In another preferred embodiment the display device 108 is in the form of a cellular telephone 184 having a display screen 152 and is connected to a communication system 106 for receiving media from the media repository 102. As illustrated in FIGS. 19 and 20, the display device includes one or more sensors 116 attached to or incorporated into the case 186 of the cellular telephone 184 that operate to obtain scanned information 120 and uses the cellular communication system to transmit the scanned information 120 to one or more identification data centers 114. Preferably, the cellular telephone 184 includes various types of use sensors 172, such as facial sensors, fingerprint sensors, pressure sensors, facial recognition sensors, eye scanning censors, voice sensors, and other types of use sensors that can be utilized for providing scanned information 120 that can be utilized by the one or more identification data centers 114 for comparing with reference data 122 for identifying the individual. It should be understood that the use sensors can also be used to obtained scanned information that allows the one or more identification data centers (or the media repository) to make a determination that the cellular telephone is no longer being held by an individual, which, depending on the media protocol, could cause the media repository to stop or pause the transmission of the media. In a preferred embodiment, the cellular telephone includes sensors 116 are in the form of sound sensors or image sensors, that operate to obtain scanned information (such as in the form of sounds) that can be used by the one or more identification data centers in determining if another individual has entered the display viewing area.

### Portable Media Receiving Unit and Authorization User Device

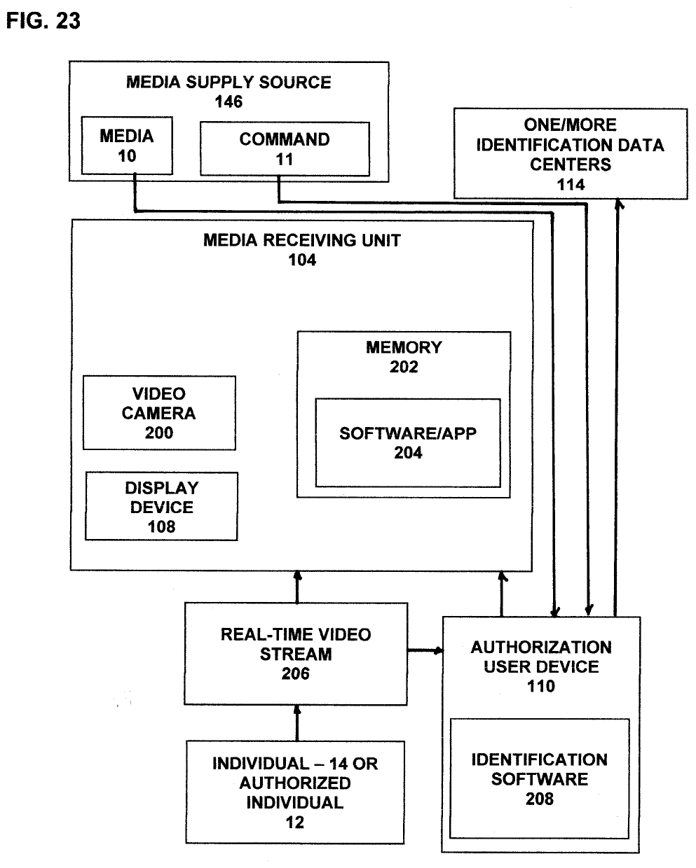

In another preferred embodiment of the invention, as illustrated in FIG. 23, the media receiving unit 104 is a portable system, such as a laptop, tablet, cell phone, or is in the form of a stationary system, such as a stationary computer system. The media receiving unit 104 includes a display device 108 and a video camera 200, such as typically incorporated in such portable systems or that can be connected to a stationary computer system that operates to take a real-time video stream 206 of the individual using the media receiving unit. Typically, such media receiving unit includes a memory 202 for storing software or an app 204 that interact with the video camera 200 to obtain the video stream 206 (scanned information) when turned on by the individual using the media receiving unit 104 or is turned on by another app or software. For example, video conference software or apps are often used to allow an individual to participate in a video conference whereby individuals participating in the conference wish to allow other participants to view them during the video conference. Such video conference software or app interact with the video camera software or other software to activate the video camera and transfer the real-time video stream, such as through the internet, for viewing by the conference participants. In the preferred embodiment, the authorization user device 110 is connected to the media receiving unit 104, such as by wire or a Bluetooth connection, and includes identification software 208 that interacts with the software or app 204 that operate the video camera 200 to obtain a real-time video stream 206 (scanned information) showing the individual using the media receiving unit 104. The authorization user device 110 then transmits the real-time video stream 206 showing the individual that is in front of the display device 108 on the media receiving unit 104 to one or more of the identification data centers 114, for use in determining if the individual shown in the real-time video stream 206 is an authorized individual 12, as described above. If the individual is not an authorized individual, the authorization user device receives a command 11 preventing the media 10 from being transmitted to the media receiving unit 104 for viewing on the display device 108. It should be understood that if the individual deactivates the camera or is no longer in view of the camera or another individual comes into view of the camera, the one or more identification data center will operate with the media repository and the authorization user device to pause or stop transmission of the media to the media receiving unit. It should also now be apparent that the system allows media supply sources, such as HULU, NETFLEX, PRIME VIDEO and the like, to offer streaming services to authorized individuals (individuals that have paid for the streaming service) and unlike using just password identification, the system described herein significantly reduces the likelihood of unauthorized individuals to receive such streaming services without paying for the service. Further, the system allows the streaming services (media supply source) to determine authorized individual and allow such authorized individuals to use their media receiving units, such as when an authorized individual travels to other locations, such as an airport, hotel, etc. Further, the streaming service providers (media supply source) can develop various financial plans, such as those based on the number of authorized individuals. It should also be apparent that the system allows for increased security with a minimum number of sensors (video camera) and uses already installed sensors (video camera already installed in the media receiving unit — routinely installed on a media receiving unit or easily installed, such as a video camera on a stand-alone stationary computer) to be utilized. It should also be apparent that other already installed sensors, such as a fingerprint reader, can also be incorporated and used by the authorization user device together with the real-time video camera to acquire scanned information for use to verify the individual is an authorized individual.

### Display Device—Windshield Configuration

In another preferred embodiment the display device 108 includes a display screen 152 in the form of a vehicle windshield 188. As illustrated in FIGS. 1 and 21, the windshield 188 is installed on the windshield frame of a vehicle 17 and includes a frame 189 having an outer top and bottom horizontal frame components 190 and two parallel frame components 192 extending downwardly from the outer top horizontal frame component 190. Preferably positioned along the frame is a sound system 154 for allowing an authorized individual the ability to hear the audio portion of media and includes a microphone component connected to a transmitter 208 that communicates with the media receiving unit 104 and operate together to allow an authorized individual with the ability to communicate with other individuals 14 using the communication system 106. A plurality of sensors 116 are positioned along the top horizontal frame component 190 and/or the two parallel frame components 192 that operate to obtain scanned information 120. A media receiving unit 104 is in communication with the sensors 116 and is incorporated within the frame 189 or is separately attached to the vehicle. Scanned information 120 is transmitted to one or more identification data centers 114 as described above. It should be understood that use sensors 172 can also be incorporated along the frame 189 and used to obtained scanned information for use in identifying an individual wishing to view media as disclosed herein above. It should be understood that other sensors can be placed within the passenger compartment (not shown) of the vehicle 17 (display viewing area) that together with other sensors operate to determine the number of individuals in the vehicle 17 as disclosed herein above. It should also be understood that if a determination is made that the individual wishing to view the media is not an authorized individual, the media supply source 146 transmits a command 11 to the authorization user device 110 to stop transmitting media 10 to the media receiving unit 104. Further in a preferred embodiment of the invention the authorization user device 110 is in electrical communication with the vehicle ignition system 19 and if the authorization user device 110 receives a command 11 to stop transmitting media to the media receiving unit, the authorization user device 110 operates to disengage (deactivate) the ignition system 19, such as activating a switch, that shuts off the vehicle 17.

### Sensor Operation

As illustrated in FIG. 2, the security system for receiving and viewing media can be configured to protect media being viewed using various types of display devices. For display devices 108 positioned within a predefined display viewing area 118, one or more sensors 116 can be strategically positioned within and/or around the display viewing area 118 that are capable of detecting the presence of an individual within the predefined display viewing area 118. In operation, the one or more viewing sensors 116 operate to obtain scanned information 120 which is transmitted to one or more identification data centers 114 that operate to make a comparison 130 of the scanned information 120 to reference information 122 for use in making a determination 132 if an individual is within the display viewing area 118.

In another preferred embodiment of the invention, the system 100 includes one or more sensors 116 placed within the display viewing area 118 that operate to obtain scanned information 120 which is transmitted to one or more identification data centers 114 that operate to make a comparison 130 of the scanned information 120 to reference information 122 for use in making a determination 132 as to if an individual is an authorized individual and/or the number of individuals within the predefined display viewing area 118 and/or if an individual has entered or left the display viewing area 118 and/or if the display device 108 has been moved out of the display viewing area 118. Further, the sensors 116 can also collect scanned information 120 which can be sent to the one or more identification data centers 114 to make a determination 132 (or sent to the media repository) to make a determination if there is a device within the display viewing area 118 that is making an unauthorized recording or transmission of the media. Preferably, the one or more sensors 116 can operate continuously to obtain scanned information 120 which is continuously transmitted to the one or more identification data centers 114 that operate continuously to make comparisons 130 of the scanned information 120 to reference information 122 for use in making a determination 132 if an individual has entered or exited the display viewing area 118 or the number of individuals within the display viewing area has changed, or if the display device has been moved. It should be understood that reference information can comprise previous scanned information which is stored in the data bank of the one or more identification data centers. For a non-limiting illustrative example, such reference information can be thermal scan of an area that indicates one individual is positioned on a seat in the display viewing area. At a later time, the scanned information can be a thermal image indicating there is no individual (or a larger number of individuals) within the display viewing area. Thus, a comparison will indicate that there an individual has left the display viewing area or that one or more additional individuals have entered the display viewing area.

### Authorization

In addition to one or more sensors 116 that can operate to determine the presence or absence of an individual in the display viewing area 118, the system 100 includes authorization information 196 for use in determining if that individual is an authorized individual for viewing the media. Such authorization information 196 can include certain identification information, such as a password, social security number, employee number or any other scanned information that can be used to verify the identity of an individual. Such authorization information 196 is then transmitted to the one or more identification data centers 114 that makes a comparison 130 with reference information 122 containing such authorization information 196 for verifying the identity of the individual and/or to the media repository 102 that utilizes the authorization information 196 and protocols 148 for the media wishing to be viewed to ensure the individual is an unauthorized individual. In another preferred embodiment, the system includes one or more use sensors 172, such as biometrics sensors, such as, but not limited to, fingerprint sensors, hand geometry sensors, facial sensors, color sensors, voice sensors, eye biometrics (iris and retina sensors) that uses conventional pattern recognition software and methods are used for acquiring scanned information 120 and the scanned information 120 from the use sensors 172 is transmitted to the one or more identification data centers 114 as authorization information 196 that operate to make a comparison 130 of the scanned information 120 (authorization information) with reference information 122 and operates to make a determination 132 as to the identity of the individual and also sends the comparison 130 to the media repository 102 which operates to make a determination 132 based on the comparison 130 and the protocols 148 for the media that the individual wishing to view the media is an authorized individual.

### Data Analysis

As illustrated in FIG. 3, each identification data center 114 includes a processor 198 that cooperates with a data analysis module 200 stored in the data banks 124 of the one or more identification data centers 114 and has conventional comparison software 202 that operates to compare the scanned information 120 with reference information 122 and in a preferred embodiment, makes a determination 132, or cooperates with the media repository 102 in making a determination 132, if the scanned information 120 is consistent with the reference information 122 for that particular individual wanting to view the media. For an exemplary illustration, the data analysis module of an identification data center operates to compare the individual voice (scanned information) of an individual and compares it with the individual's voice stored in its memory (reference information) and uses a convention voice analyzer to determine if the voices match. Other scanned information, such as the individual's finger print and/or the individual's password and/or facial image (scanned information) is compared, such as to finger print, individual password and/or facial image (reference information) and using such conventional comparison methods for such scanned information a determination if the scanned information matches the reference information for the individual. In another exemplary non-limiting illustration, such as in the case of a display device being in the form of a cellular telephone, the system includes a finger print sensor such that when an individual pushes numbers or letters on a display screen (for example to enter a password), the system operates such that the individual's finger print (obtained from a sensor located on the input device, and the password together comprise the scanned information which is then used by the one or more identification data centers to verify the identity of that individual and a determination is made that the individual is an authorized individual. It should be understood that if the individual is determined not to be an authorized individual, media is not transmitted to the display device and preferably, the display device can be deactivated (except for the ability to obtain scanned information and transmit it to the one or more identification data centers, which when a determination is made that the user is an authorized individual and the display device is reactivated. Thus, the system and method of the subject invention operates to provide additional security to the various display devices using the system.

Once the one or more identification data centers 114 have completed the comparison, it transmits the results of the comparison to the control unit 144 of the media repository 102 whereby the administrative module 134 then operates to make a determination 132 if the individual wanting to view media is an authorized individual. In a preferred embodiment, the various comparisons are weighted comparisons and the administrative module utilizing fuzzy logic and the weighted comparisons, operates to make a determination if the individual wanting to receive and view media is an authorized individual or is actively viewing the media being transmitted to the display device is the authorized individual. For an illustrative example, the fuzzy logic utilized by the administrative module operates to give weight to all of the comparisons. For example, if a comparison is a finger print comparison, it may be given greater weight, lesser weight, or equal weight than a comparison of the voice of an individual or a comparison of passwords. The data analysis module then operates to compute and makes a determination as to if the individual wanting to view the media is or is not an authorized individual based on the comparisons and in accordance with the weight given to each comparison.

To further understand the operation of the administrative module and the fuzzy logic utilized, the following non-limiting exemplary illustration is provided. In a preferred embodiment of the invention, the one or more sensors 116 are effective for collecting the following scanned information 120 (it being understood that different or other scanned information may be utilized and the following is only a non-limiting illustration) and scanned information 120 is transmitted to one or more identification data centers 114:
Fingerprint—the scanned information comprises a scanned fingerprint of the individual wanting to view media.
Voice—scanned information comprises the voice of the individual wanting to view media.
Password—The scanned information comprises a password inputted into the system (such as by way of voice or other conventional methods of input).
Eye Scan—The scanned information comprises a scan of the eye of the individual wanting to view media.
Temperature—Measured as the average temperature of a portion of the skin of the individual wanting to view the media.
Face Scan—The scanned information comprises an image of the face of the individual wanting to view the media.
Weight—The applied weight or pressure (E.g., pressure sensors) comprises of the weight or the pressured force of the individual wanting to view the media (side note: the weight can be added to a component to insure that the individual wanting to view the media does not abstract the viewed media without permission [an example would be placing pressure sensors under a laptop for extra security, in case someone tries to place a unknown device on the bottom of the laptop to obtain/record the viewed media without permission]). An example of applying pressure sensors is in the seat of a car to view the media (I.e., a digital display) or having the individual who wants to view the media add a certain amount of pressure to a button (that button in this example may be the final step to allowing the individual who wants to view the media to do so).
   The data analysis module 200 of each of the one or more identification data centers 114 operates to compare the scanned information 120 received by the data analysis module 200 with reference information 122 and makes a comparison 130 using appropriate conventional comparison software 202 of the scanned information 120 with the reference information 122 for that particular individual wanting to view the media. For a non-limiting exemplary illustration, the data analysis module of an identification data center operates to compare the individual voice (scanned information) and compares it with the individual's voice stored in its memory (reference information) and uses a convention voice analyzer to determine if the voices match. Other scanned information, such as the individual's finger print and/or the individual's password and/or facial image (scanned information) is compared to finger print, individual password and/or facial image (reference information), respectively, and using conventional comparison methods for such scanned information makes a comparison of the scanned information with the reference information for the individual. Once the data analysis module completes the comparison, the identification data center transmits the comparison to the transmitting/receiving module of the media repository. The administrative module then cooperates with the processor to use the comparison(s) to make a determination if the individual wanting to view the media is or is not an authorized individual. Accordingly, the various comparisons may be weighted. For example, passwords (thus, a password comparison) may have less weight than a facial comparison which may have less weight than a fingerprint comparison. Using such comparisons (weighted or not weighted) the administrative module of the media repository operates using fuzzy logic to determine if the individual wanting to view the media is an authorized individual. It should also be understood that the system is not limited to fuzzy logic systems but that other logic systems such as Bayesian logic, artificial neural networks, and other like systems can also be used. It should be understood that the fuzzy logic systems can include artificial technology to determine the weight of the various comparisons, such as the likelihood that the likelihood that the scanned information maybe false information or the accuracy of the sensor obtaining scanned information and other such factors.

It should now be apparent that the subject invention is a system and method that provides security for receiving and displaying media. Unlike prior art security systems, the method and system of the subject invention provides security for receiving and viewing media, such as on-line streaming media, and further operates to provide security for the software and the devices used in the transmission and display of such media and also provides security for the media when being displayed for use by an individual. The system and method of the subject invention also operates to ensure that only an authorized individual or individuals are able to view the media. The system and method of the subject invention operates such that media being displayed to an authorized individual is protected from the point that the media is transmitted from a media repository to a media receiving unit, but also protects the media being displayed from being observed by unauthorized individuals. It should also now be apparent that the system and method of the subject invention can be used for various applications, such as for individual viewing (headsets, televisions, tablets, cellular telephones, watches, gaming systems avatar systems, movie screens, large screen systems, vehicle windshields, and the like) or for group viewing (televisions, headsets, tablets, cellular telephones, large screens (movie theaters, class rooms, conference rooms and the like). It should also be apparent that the amount of security can be easily increased or decreased by utilizing more or less sensors, sensor timing (time between scans) and types of sensors. It should also now be understood that the use of multiple independent identification data centers having stored reference information for use in receiving and comparing scanned information (which is re-encrypted) with the reference information reduces the likelihood of the system being “hacked” resulting in security breaches and the likelihood that media is displayed and viewed by unauthorized individuals. It should now be apparent that the system and method of the subject invention provides security along the entire process and components utilized for the transmission of media from a media repository to the display device for use by an individual in viewing the transmitted media. In addition, the system and method can be used for various applications. For example, the system and method can be used for individuals to protect media being viewed on small display devices such as cellular telephones, tablets and computers and that such systems will have additional security preventing such devices from being used by an unauthorized individual. Media suppliers, such as motion picture distributers, can now limit individuals viewing media to those who have paid to watch such media. For example, an individual who paid to watch media, such as a movie, on a display device, such as a television, computer or tablet can watch the media but if an individual who has not paid to watch the media would be prevented from watching the media until paying to become an authorized individual. Installing and using the system and method of the invention for use in vehicles, such as military vehicles, for example, will ensure that only authorized individuals will receive and be able to view classified information, such as troop movements. It should also now be apparent that the system of the subject invention operates to reduce the likelihood of an unauthorized individual from viewing sensitive or confidential information and also operates to reduce the likelihood of a “hacker” from being able to gain unauthorized access to the system or to information stored in the system.

It should also now be apparent that the system and method of the subject invention can be used as a “digital passport” whereby media providers (or individuals on a social platform) can monitor their media and who has access to their media being posted, such as on social media sites, and can now regulate who has permission (who is an authorized individual) to view and use the posted media. It should also now be apparent that the system and method of the subject invention can be used for various transactions that require security. For example, if someone wanted to vote, such as in a business meeting on a digital device and does not want others to view who they voted for, the subject invention can provide the necessary protection. In another example, a professor wants to make sure that the student(s) were at home taking a test and had paid for an additional book prior to that test to ensure that student had all the materials needed to study for that test/exam; or that during an exam there is no one around providing notes or the answers (i.e., a person standing where or near a laptop's cameras blind spot is or an area where a person cannot be seen). It should also now be apparent that the system and method can operate to convert the rights from one person to another to buy certain item(s) online, because both people will be identified (in a unique manner); even if both people use the same account (e.g., mother and son). for example, a mother buys tickets for her and daughter online to watch movies. The mother's son is in college in his dorm and wants to watch that very same movie online as well but does not have any money. The mother uses the system of the subject invention to identify that she is the primary person on the account and that she is the mother to the son and that she wants to send her son $15 to buy a ticket using her account. The son does not need to know the mothers card number or bank account number, the son just needs to be identified using the subject system. The son is the only person in his dorm room, so he can watch a movie, but if his cousin walks in the room, then the movie will not play until his cousin buys a ticket.

It should also be understood that the system and method of the subject invention can be utilized on various devices and systems. In another preferred example, if a windshield, such as a car windshield, is used for the display the system and method of the subject invention operates to ensure that only an authorized individual can view the information being displayed and if another unauthorized individual or a unauthorized device is viewing or transmitting the information, the system will operate to pause or terminate the transmission and display of the information (media). The system can also scan an individual's driver's license to show how old someone is (e.g., to check their age in order to purchase a movie ticket) or scan a credit card(s) to make a certain purchase.

In another preferred example, a bank or financial institution system can be integrated into this system of the subject invention or cooperates with the system of the subject invention. For instance, if an individual wants to add money to their account, the bank could wait for the system of the subject invention to identify the individual. Once that person has been identified this individual can put money into their account that a bank manages, for example money to buy movie tickets or an online purchase.

Another example is if an individual (Person A) wants to send money to another account or person; in this case Person B (this transaction can be for many reasons [for example: Person A may want to buy movie tickets, such as to stream new movies online, from Person B, even if Person B is not at home, Person A can still send the money to Person B and Person B can tell Person A that Person C will represent them or have permission to take the money and that Person B is responsible for what Person C does, however all Person C can do [in this example] is be identified by the system of the subject invention and accept the amount. The amount will go to Person B's account and Person C does not need to be identified to Person A. Person A will get a notice that Person B has received the funds or amount. Therefore, allowing Person A to receive their movie tickets.

In describing the preferred embodiments of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

While various components, such as the display device, the authorization user device, encryption security mechanism and the media receiving unit has been described as separate components, it should be understood that such components can be combined and/or incorporated into one component.

1. A system for providing security media being viewed or wishing to be viewed by an individual, the system comprising:
a media repository having media;
an authorization user device;
a media receiving unit;
a communication system for transmitting media from said media repository to said authorization user device and to said media receiving unit;
a display device in communication with said media receiving unit that displays said media;
one or more sensors that operate to obtain scanned information, wherein said scanned information is transmitted to said authorization user device that sends said scanned information to one or more identification data centers;
wherein said one or more data centers operate to make a comparison of said scanned information with reference information; and
wherein using said comparison a determination is made if the individual viewing the media or wishing to view said media is an authorized individual, and if the determination is that the individual is not an authorized individual, said media repository sends a command to said authorization user device to stop sending said media to said media receiving unit.

2. The system of claim 1 wherein the media is streaming media.

3. The system of claim 1 wherein said scanned information being transmitted to said one or more identification data centers is encrypted by said authorization user device and is re-encrypted when scanned information is received by said one or more identification data centers. An Al support system can also be integrated into this process for support.

4. The system of claim 1 wherein said one or more sensors operate to obtain scanned information which is used to determine if an individual has entered said display viewing area and wherein if an individual has entered said display viewing area, the display of the media on said display device is stopped.

5. The system of claim 1 wherein said scanned information is used by said one or more identification information data centers to make a determination if an object capable or being used to record media being displayed by said display device or is transmitting said media to a location outside said display viewing area.

6. The system of claim 1 wherein said display device is in the form of a headset.

7. The system of claim 1 wherein said display device is in the form of a headset for use by an authorized individual and includes one or more sensors that transmit scanned information to said authorization user device that encrypts said scanned information and transmits said encrypted scanned information to one or more individual identification data centers that operate to determine if the individual wearing the headset is an authorized individual.

8. The system of claim 1 wherein said display device includes a sound system that utilizes conventional bone conducting technology for transmitting sound waves converted into vibrations that are received directly by a user's Cochlea (the sound system just like the overall system can integrate with one or more sensors (I.e., skin sensor, biometric sensors).

9. The system of claim 1 wherein said one or more sensors are placed within said display viewing area that operate to obtain scanned information which is used by said one or more identification data centers to make a determination as to the number of individuals within said display viewing area.

10. The system of claim 1 wherein said one or more sensors are placed within said display viewing area that operate to obtain scanned information and wherein said one or more identification data centers make a comparison of said scanned information with said reference information and wherein a determination is made as to if an authorized individual viewing the media being displayed on said display device has entered or left said media viewing area.

11. The system of claim 1 wherein said display device is in the form of a computer or a tablet or a cellular telephone or a television or a large screen system or a watch, or a helmet, or a vehicle windshield.

12. The system of claim 1, wherein said scanned information is weighted and a comparison is made using such weighted scanned information and a determination is made using said weighted scanned information if the individual viewing the media or wishing to view the media is an authorized individual.

13. The system of claim 1 wherein said one or more sensors are placed within a display viewing area that operate to obtain scanned information and wherein said one or more identification data centers make a comparison of said scanned information with said reference information and wherein a determination is made as to if an authorized individual viewing the media being displayed on said display device has entered or left said display viewing area.

14. A vehicle having a system for providing security for media being viewed or wishing to be viewed by an individual, the system comprising:
a windshield attached to the vehicle;
a media source located outside the vehicle;
a media receiving unit installed in said vehicle;
a communication system for transmitting encrypted media from said media source to an authorization user device installed in the vehicle;
wherein said windshield in in communication with said media receiving unit and displays said media;
one or more sensors for obtaining scanned information and transmits said scanned information to said authorization user device;
wherein said authorization user device transmits said scanned information for use in making a determination if the individual is an authorized individual;
wherein if said determination is that the individual is not an authorized individual, said media source transmits a command to said authorization user device to stop transmitting said media to said media receiving unit.

15. The system of claim 14 wherein said scanned information transmitted by said authorization user device to one or more identification data centers, wherein said scanned information is encrypted and re-encrypted when received by said one or more identification data centers.

16. The system of claim 14, wherein said scanned information is weighted and a comparison is made using such weighted scanned information for use in making said determination as to if the individual viewing the media or wishing to view the media is an authorized individual.

17. The system of claim 14 wherein said one or more sensors are placed within said vehicle to obtain said scanned information and wherein said scanned information is transmitted to one or more identification data centers and wherein said determination is made as to the number of individuals within said vehicle.

18. The system of claim 14 wherein said authorization user device is in electrical communication with a ignition system and if said determination is that the individual is not an authorized individual, said media source transmits a command to said authorization user device to deactivate said ignition system.

19. A system for providing security media being viewed or wishing to be viewed by an individual, the system comprising:
a media source;
an authorization user device in communication with said media source;
a media receiving unit having a display device and a video camera, wherein said media receiving unit is in communication with said authorization user device;
wherein said video camera takes real-time video showing an individual;
wherein said real-time video is transmitted to said authorization user device and said authorization user device transmits said real-time video to one or more identification data centers as scanned information;
wherein said scanned information is compared to reference information and said comparison is used to make a determination is said individual shown on said real-time video is an authorized individual; and
wherein if said determination is that the individual is not an authorized individual, said media source transmits a command to said authorization user device to stop transmitting said media to said media receiving unit.
